(19) United States
(12) Patent Application Publication
(10) Pub. No.: US 2026/0168810 A1
(43) Pub. Date: Jun. 18, 2026

(54) INFORMATION MANAGEMENT APPARATUS, SYSTEM, AND COMPUTER-READABLE STORAGE MEDIUM

(71) Applicant: HONDA MOTOR CO., LTD., Tokyo (JP)

(72) Inventors: Tsuyoshi NOJIRI, Wako-shi (JP); Naotoshi FUJIMOTO, Wako-shi (JP); Ryo IITAKA, Wako-shi (JP); Takashi OSHIMA, Wako-shi (JP); Moriya HORIUCHI, Wako-shi (JP)

(73) Assignee: HONDA MOTOR CO., LTD., Tokyo (JP)

(21) Appl. No.: 19/398,797

(22) Filed: Nov. 24, 2025

(30) Foreign Application Priority Data
Dec. 13, 2024 (JP) 2024-218965

(51) Int. Cl. G01C 21/36; G01C 21/34; G10L 15/08; G10L 15/22

(52) U.S. Cl. CPC G01C 21/3655; G01C 21/3453; G10L 15/083; G10L 15/22

(57) ABSTRACT

An information management apparatus that manages information about a user, comprises an analysis unit configured to analyze a conversation between the user and at least one third party different from the user, an identification unit configured to identify an intimacy degree between the user and the at least one third party, based on an analysis result by the analysis unit, and an evaluation unit configured to evaluate the user, based on an identification result by the identification unit.

### CROSS-REFERENCE TO RELATED APPLICATION(S)

This application claims priority to and the benefit of Japanese Patent Application No. 2024-218965, filed Dec. 13, 2024, the entire disclosure of which is incorporated herein by reference.

### BACKGROUND OF THE INVENTION

### Field of the Invention

The present invention mainly relates to an information management apparatus.

### Description of the Related Art

In recent years, efforts have been made to provide a sustainable transportation system that gives consideration to people in vulnerable situations among traffic participants. With regard to preventive safety technology to achieve such a transportation system, research and development for further improving traffic safety and convenience are focused on (see Japanese Patent No. 7523347).

As the preventive safety technology, it is needless to say that the generally applicable technology is demanded, but the technology corresponding to every region can be also demanded.

The present invention provides a technology that is advantageous for improving regional safety, which contributes to development of a sustainable transportation system, accordingly.

### SUMMARY OF THE INVENTION

A first aspect of the present invention provides an information management apparatus that manages information about a user, the information management apparatus comprising an analysis unit configured to analyze a conversation between the user and at least one third party different from the user, an identification unit configured to identify an intimacy degree between the user and the at least one third party, based on an analysis result by the analysis unit, and an evaluation unit configured to evaluate the user, based on an identification result by the identification unit.

### BRIEF DESCRIPTION OF THE DRAWINGS

FIG. 1 is a diagram illustrating an example of a configuration of a system according to an embodiment;

FIG. 2 is a flowchart illustrating an example of processing contents of a mobile terminal;

FIG. 3 is a flowchart illustrating an example of processing contents of the mobile terminal;

FIG. 4 is a flowchart illustrating an example of processing contents of a server; and

FIG. 5 is a flowchart illustrating an example of processing contents of the mobile terminal.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

### System Configuration

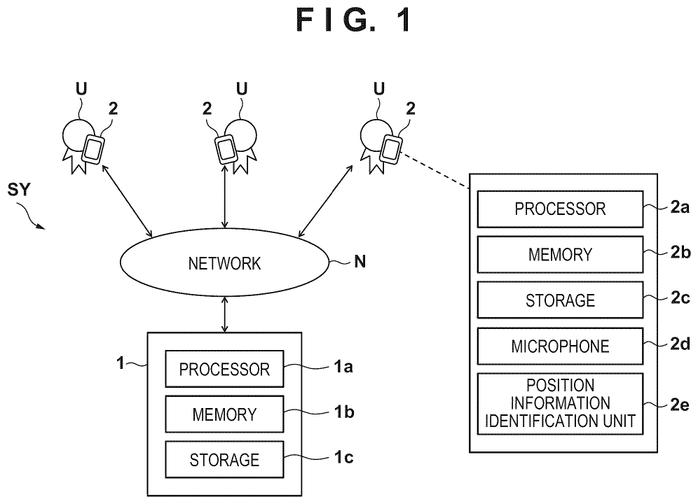

FIG. 1 is a diagram illustrating an example of a configuration of a system SY according to an embodiment. The system SY includes a server 1 and one or more (here, three) mobile terminals 2. The server 1 and the individual mobile terminals 2 are capable of communicating with each other through a network N.

The server 1 includes a processor 1a, a memory 1b, and a storage 1c. The processor 1a is an operation unit that performs arithmetic processing for enabling each function in the server 1 in a broad sense, and includes, for example, a central processing unit (CPU), a micro processing unit (MPU), a graphics processing unit (GPU), and the like. The memory 1b is a storage medium that temporarily stores intermediate data and the like for use in the arithmetic processing of the processor 1a, and a volatile storage medium such as a random access memory (RAM) or a read only memory (ROM) can be typically used. The storage 1c is a storage medium that stores information necessary for the arithmetic processing of the processor 1a, such as programs and parameters, data indicating a result of the arithmetic processing, and the like, and a non-volatile storage medium such as a hard disk drive (HDD) or a solid state drive (SSD) can be typically used.

The server 1 may further include: an operation input unit such as a hardware key, a software key, or a lever; and a display unit such as a liquid crystal display or an organic EL display, so an administrator of the server 1 is able to input or update necessary information using the operation input unit and the display unit. The administrator of the server 1 corresponds to a provider of a service to be described later, and the service is provided for the individual mobile terminals 2 through the network N.

It is assumed that one or more mobile terminals 2 are respectively associated with one or more users U. The association described here is sufficient if the user U is registered as the owner of the mobile terminal 2 or the user U actually owns the mobile terminal 2. Each of the mobile terminals 2 includes a processor 2a, a memory 2b, and a storage 2c. The processor 2a, the memory 2b, and the storage 2c may be configured to be respectively capable of enabling functions similar to those of the processor 1a, the memory 1b, and the storage 1c. As the mobile terminal 2, a known portable terminal such as a smartphone, a tablet terminal, or a wearable device can be typically used.

Each of the mobile terminals 2 further includes a microphone 2d and a position information identification unit 2e. The microphone 2d is capable of acquiring sound information in the surroundings of the user U, in addition to utterances of the user U, by using its sound collection function. The position information identification unit 2e is configured to be capable of identifying position information of the self-device (the mobile terminal 2), and its function is enabled using, for example, a global navigation satellite system (GNSS).

The outline of the service according to the present embodiment (hereinafter, referred to as the present service) is to promote improvement in lifestyle of the user U using the mobile terminal 2, to promote improvement in sociability of the user U, and to achieve improvement in regional safety, accordingly. A program (hereinafter, referred to as the present program), as a part of the present service, distributed from the server 1 is installable in the mobile terminal 2. Before receiving the present service, the user U is able to download the present program through the network N and install the present program in the mobile terminal 2, in many cases.

The present service is mainly available when the user U goes out with the mobile terminal 2. In many cases, the user U is a school student (younger than 18 years old) who attends school, but may be a grown-up (18 years old or older).

### Processing Contents of Mobile Terminal in The Present Service

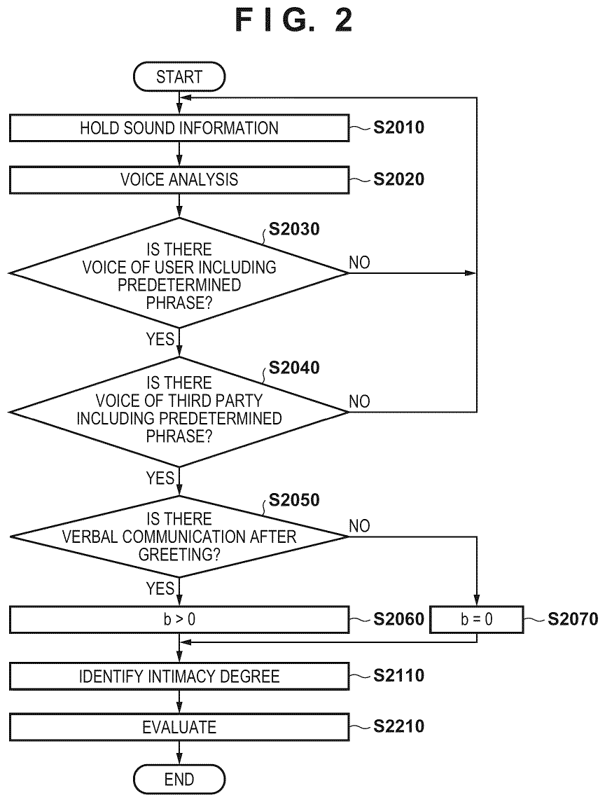

FIG. 2 is a flowchart illustrating an example of processing contents of the mobile terminal 2. The outline of the present flowchart is to evaluate the user U, based on conversation between the user U and a third party, and the following steps can be mainly performed by the processor 2a. The present flowchart can be started, for example, based on activation of the present program by an operation input into the mobile terminal 2 or based on power-on of the mobile terminal 2 in which the present program is installed.

In step S2010 (hereinafter, referred to as “S2010”, which will also apply to the other steps to be described later), sound information in the surroundings of the user U is temporarily held in the memory 2b. The microphone 2d (see FIG. 1) enables this step. It is sufficient that the sound information held in the memory 2b includes information of uttered voice (voice information) of the user U and the surroundings of the user U. Therefore, the sound information to be held in the memory 2b is desirably in an audible frequency band (between 20 Hz and 20 kHz), but may be in a frequency band (between 250 Hz and 2000 Hz) of typical daily conversation. Therefore, with regard to a recording result by the mobile terminal 2, remaining bands except for the above frequency bands may be removed in known filtering processing. In addition, for example, information of environmental sounds such as rain or wind or noise sounds is unnecessary, so known noise removal processing may be further performed.

Note that it is sufficient that the sound information held in the memory 2b has an information amount of approximately several seconds to several tens of seconds or approximately several minutes, and previous sound information may be deleted from the memory 2b.

In S2020, voice analysis is conducted on the sound information held in S2010, and it is determined whether the sound information includes voice of the user U.

The voice of the user U may be registered beforehand, and may be registered at the time of initial settings (for example, at the time of user registration) after the program is installed in the mobile terminal 2. Registration of the voice of the user U is enabled by means similar to known voiceprint authentication. For example, it is possible for the user U to input one or more voice patterns into the mobile terminal 2, and feature data that has been extracted through voiceprint analysis of them can be registered. The voice analysis in S2020 is enabled by matching speech waveforms using such feature data.

In a case where the voice of the user U are present, the processing proceeds to S2030, and in the other case, the processing returns to S2010.

In S2030, it is determined whether the voice of the user U confirmed in S2020 include a predetermined phrase. This determination is enabled by means similar to known voice analysis. For example, it is possible to determine whether the voice of the user U include a predetermined phrase, based on phonemes that have been extracted from the voice information through acoustic analysis.

It is sufficient that the predetermined phrase mentioned here is a phrase related to a lifestyle. It is assumed that as its typical examples, phrases indicating greetings are set beforehand. A plurality of types of greeting phrases may be set for each time of day. Hereinafter, in order to facilitate the description, it is assumed that two types of phrases “Good morning” and “Morning” are set as the plurality of types of phrases each indicating a morning greeting.

In a case where the voice of the user U include the predetermined phrase (in the present example, a greeting such as “Good morning” or “Morning”, which will be hereinafter referred to as the “greeting phrase”), the processing proceeds to S2040, and in the other case, the processing returns to S2010.

In S2040, the voice analysis is further conducted on the sound information held in S2010, and it is determined whether the voice of a third party for a greeting phrase are present before or after the voice of the user U for the greeting phrase confirmed in S2030. In a case where the greeting phrase of the third party is present, the processing proceeds to S2050 on the assumption that the greetings have been exchanged, and in the other case, the processing returns to S2010.

Here, it is sufficient that the voice of the third party are different from the voice of the user U (it is sufficient that the voice of the third party are distinguished from the voice of the user U). Thus, in the determination of S2040, the voice of the third party may not necessarily be registered in the mobile terminal 2.

In S2050, in the sound information held in S2010, it is determined whether verbal communication has continued subsequent to the greeting phrase of the user U confirmed in S2030. The verbal communication is conducted between the user U and the third party, who is different from the user U. In the present example, it is sufficient if some kind of verbal communication continues subsequent to the greeting (for example, it is sufficient that the voice of the user U and the voice of the third party are alternately repeated at least once), and its contents do not matter.

In a case where the verbal communication is conducted after the greeting, a parameter b to be described later is set to establish b>0 in S2060, and in a case where there is no verbal communication after the greeting, a parameter b to be described later is set to establish b=0 in S2070.

In this manner, in S2010 to S2050, the conversation conducted between the user U and the third party is analyzed. According to the present example, in a case where the voice of the user U include a greeting phrase, the voice analysis is started, that is, it can be said that the greeting phrase serves as a trigger for starting the voice analysis.

In S2110, an intimacy degree between the user U and the third party is identified (or calculated), based on an analysis result (see S2010 to S2050). The intimacy degree mentioned here may be an index indicating a degree of mutual recognition between the user U and the third party, and is not limited to the contents or frequency of daily or actual relationship. Note that in a case where the user U greets a plurality of third parties, the intimacy degree with each of the plurality of third parties is identified.

In the present example, the intimacy degree with the third party can be calculated, based on the type of the greeting confirmed in S2030 and the presence or absence of the verbal communication after the greeting confirmed in S2050. For example, the intimacy degree F can be calculated in the following expression

$$F = a + b * T$$

by using a parameter “a” in accordance with the type of the greeting, a parameter “b” indicating the presence or absence of the verbal communication after the greeting, and a parameter “T” indicating the length of the verbal communication when the verbal communication is conducted.

In this expression, for example, in a case of a polite greeting (in the present example, in the case of “Good morning”), a=a1 is set, and in the case of an intimate greeting (in the present example, in the case of “Morning”), a=a2 (>a1) is set. In addition, as described above, in a case where the verbal communication is conducted after the greeting, b>0 is set, and in a case where no verbal communication is conducted after the greeting, b=0 is set.

In a case where no greeting is conducted, the intimacy degree F remains in an initial state (for example, “unrecorded” and “unevaluated”), and in a case where the greetings are exchanged, the intimacy degree F may be converted into a numerical value, based on the content. The intimacy degree F is not limited to the expression in the present example. For example, when the greetings are exchanged, and
in a case where the greeting is polite (in the present example, “Good morning”), the intimacy degree F has a low numerical value,
in a case where the greeting is intimate (in the present example, “Morning”), the intimacy degree F has a high numerical value, and in addition,
verbal communication is conducted after the greeting, the intimacy degree F may be added, and as the verbal communication becomes longer, the intimacy degree F may be further added.

In this manner, in S2110, in a case where a predetermined phrase (in the present example, a greeting phrase) is included in the conversation, the intimacy degree is identified, based on the type. Subsequently, when the verbal communication continues, the intimacy degree is identified, further based on the verbal communication.

In S2210, the user U is evaluated, based on the intimacy degree identified in S2110. In this evaluation, it is sufficient to convert the lifestyle of the user U into a numerical value, and the evaluation value can be calculated, based on the intimacy degree F with each of the plurality of third parties.

For example, in a case where k is an integer of 2 or more and the intimacy degree F(k) is set for a certain third party H(k), the evaluation value E can be calculated as

$$E = \sum F ( k ) .$$

For example, in a case where the evaluation value E has a large value, it can be said that there are lots of third parties (for example, third parties who are mutually familiar with the user U) each having a high intimacy degree with the user U, and the user U is high in sociability.

As another example, an evaluation value E′ may be calculated as

$${E}^{′} = \sum ( {F ( k )}^{- 1} ) .$$

For example, in a case where the evaluation value E′ has a large value, it can be said that the user U has a lifestyle of also actively greeting a third party who does not have a high intimacy degree with the user U (for example, an elderly person who pays attention to the user U or a third party who is senior), and the user U is high in sociability.

Thus, by calculating both of the evaluation values E and E′, the evaluation for the user U can be conducted with higher accuracy, but only one of them may be calculated. In addition, the above arithmetic expressions of the evaluation values E and E′ can be changed without departing from the gist, and are not limited to those in the present example.

An evaluation result obtained in this manner can be transmitted to the server 1 through the network N, stored in the storage 1c, and managed for every user U.

In the above example, the morning greeting phrase is indicated as the predetermined phrase referred to in S2030. However, greeting phrases for daytime, evening, and night are respectively set, and the same evaluation may be conducted in another time of day. In addition, in the above example, two types of greeting phrase are indicated. However, it is only necessary to set a plurality of types of greeting phrases.

In a case where the present service is used in arriving at or leaving school, greetings for arriving at and leaving school may be set as predetermined phrases. The morning greeting can be used for the greeting when arriving at school. On the other hand, in the greeting for leaving school, “Goodbye” as a polite greeting, “Bye” as an intimate greeting, or the like can be set as the predetermined phrases.

Note that in arriving at or leaving school, encountering a plurality of third parties is conceivable, so greetings are intermittently repeated in many cases. Therefore, in the flowchart of FIG. 2, when a new greeting is confirmed while performing in any of the steps, an interruption job may be generated (for example, to skip the determination of the presence or absence of the verbal communication after the greeting).

### Brief Summary

According to the present embodiment, the user U actively conducts the greeting, that is, it becomes possible to promote improvement in lifestyle and improvement in sociability of the user U. Furthermore, in a region where lots of greetings are exchanged, in general, a regional watching system is organized with residents, which is advantageous for preventing accidents and crimes, in many cases. Therefore, according to the present embodiment, it is also advantageous for improving the regional safety, which contributes to regional vitalization and development of the sustainable transportation system, accordingly.

According to the present embodiment, the mobile terminal 2 functions as an information management apparatus that manages information of the user U. At least a part of the processing contents performed by the processor 2a of the mobile terminal 2 may be performed by the processor 1a of the server 1, that is, the functions of the information management apparatus are enabled by the server 1 and/or the mobile terminal 2. This reasoning also applies to the other embodiments to be described below.

### Second Embodiment

As in the above-described first embodiment, by evaluating the user U, based on the intimacy degree between the user U and a third party, it is advantageous for improving the regional safety. Therefore, in a case where there are a plurality of users U in substantially the same region, it is also possible to generate a safety map indicating the regional safety by collecting a plurality of intimacy degrees obtained in evaluating them in association with the position information.

In a case where the present service further includes provision of a safety map as the second embodiment, the mobile terminal 2 is to transmit, to the server 1, evaluation results (the evaluation values E and E′) obtained in S2210 of FIG. 2 and the intimacy degree obtained in the evaluation in association with the position information. This is enabled by the position information identification unit 2e (see FIG. 1).

### Processing Contents of Mobile Terminal in The Present Service

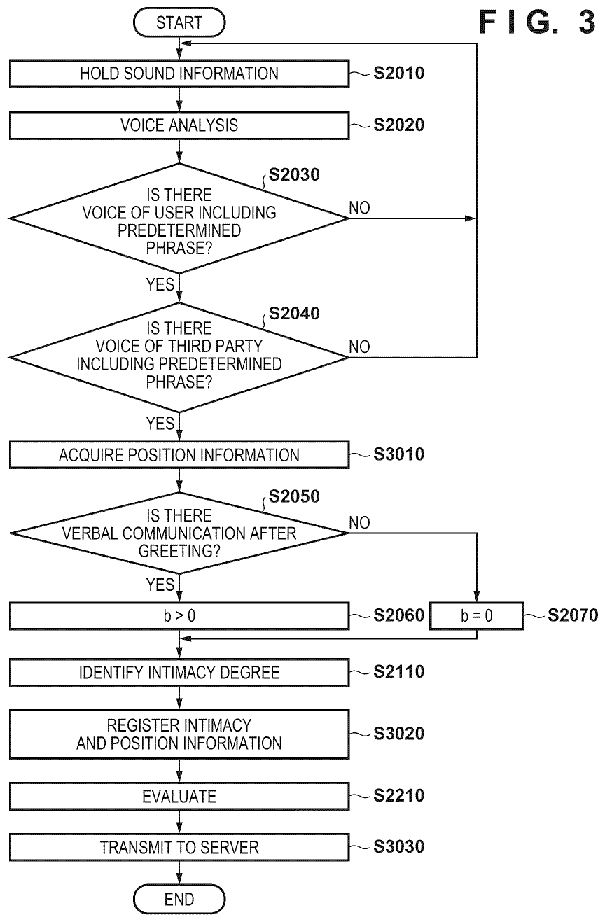

FIG. 3 is a flowchart illustrating an example of processing contents of the mobile terminal 2. In the present flowchart, when it is determined in S2040 that the greetings are exchanged (a case where the voice of a third party for the greeting phrase are present before or after the voice of the user U for the greeting phrase), the processing proceeds to S3010, and in the other case, the processing returns to S2010. In S3010, the position information of the user U is acquired using the position information identification function of the mobile terminal 2.

In addition, after S2110 and before S2210, the intimacy degree identified in S2110 is registered in S3020 in association with the position information acquired in S3010. This is enabled by storing the intimacy degree and the position information in the memory 2b, or by storing them in the storage 2c.

Then, in S3030 after S2210, the intimacy degree individually obtained in the evaluation and the position information associated with the intimacy degree are transmitted to the server 1, together with the evaluation result obtained in S2210. The evaluation result that has been transmitted is stored in the storage 1c, together with the individual intimacy degree and the position information obtained at the time of the evaluation.

According to such processing contents, the server 1 is capable of acquiring the identified individual intimacy degree in association with the position information at that time.

### Processing Contents of Server in The Present Service

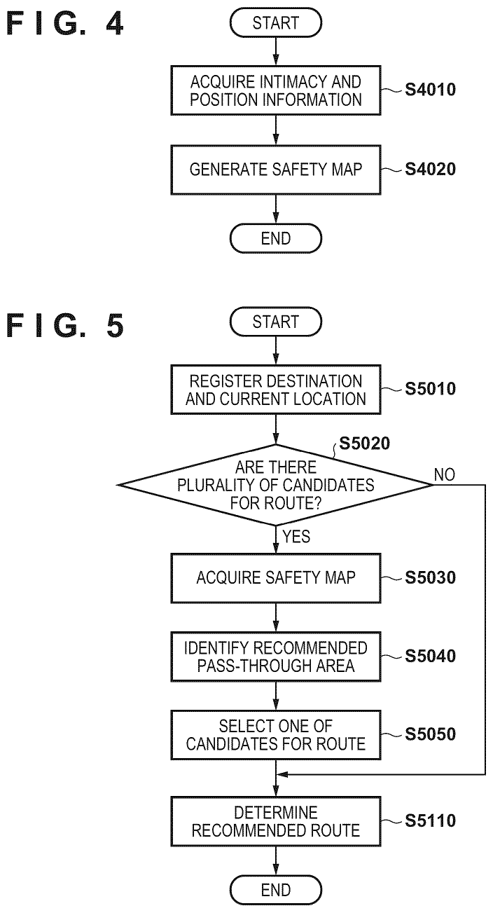

FIG. 4 is a flowchart illustrating an example of processing contents of the server 1. The outline of the present flowchart is for identifying a highly safe area in such a region, based on an identified result of the intimacy degree obtained for the individual user U and the position information at that time, and generating a safety map, based on its results. It is sufficient to start the present flowchart, for example, based on new registration or update of the evaluation value for any user U. The following steps can be mainly performed by the processor 1a of the server 1.

In S4010, the evaluation result in S3030 stored in the storage 1c is read for each of the plurality of users U, and the identified individual intimacy degree and the position information in association with the intimacy degree are acquired.

In S4020, the individual intimacy degree acquired in S4010 is registered (or plotted, mapped, or the like) on the map data of the region, based on the position information in association with the intimacy degree. The map data obtained in this manner is generated as a safety map in which regional information (mainly the safety) is manageable, or which indicates the regional safety, and becomes widely usable.

In many cases, in the safety map, it can be said that an area having a large number of registration times of the intimacy degree (that is, the number of times of exchanging greetings or making conversation) is high in safety. For example, in the safety map, an area where a large number of third parties each having a high intimacy degree with the individual user U are present or frequently encountered is indicated as, for example, a first safe area. Additionally, or alternatively, in the safety map, an area where a large number of third parties (for example, an elderly person who pays attention to the user U or a third party who is senior) each exchanging greetings with the individual user U are present even though the intimacy degrees are not high is indicated as, for example, a second safe area.

Here, the intimacy degree identified by the greeting in a certain area may be biased due to individual differences among the users U. For example, in a case where two users U exchange greetings in a certain area, two intimacy degrees are identified, but the two intimacy degrees do not necessarily have identical values. For this reason, in a case where a plurality of registered intimacy degrees are present in a certain area, they may be compensated, based on, for example, standard deviation.

According to the present embodiment, it is advantageous for further improving the regional safety, which contributes to regional vitalization and development of the sustainable transportation system, accordingly.

The processing contents of the server 1 and the mobile terminal 2 can be changed without departing from the gist. For example, some of the processing contents of the mobile terminal 2 (steps in the flowchart of FIG. 3) may be performed by the processor 1a of the server 1. Similarly, some of the processing contents (steps in the flowchart of FIG. 4) of the server 1 may be performed by the processor 2a of the mobile terminal 2.

### Third Embodiment

The safety map generated in the above-described second embodiment can be used for navigation services such as route guidance, for example. Here, the intimacy degree, which is original data for generating the safety map, is identified with the greetings exchanged as a trigger (see FIG. 2), and the greetings are generally different in phrase and frequency depending on the time of day. Hence, it can be said that the safety map changes depending on the time of day. For this reason, it can be said that the navigation service can be provided in a form according to the time of day with reference to the safety map according to the second embodiment.

As the third embodiment, in a case where the present service further includes the navigation service, it is only necessary to change the processing contents (see FIG. 3) of the mobile terminal 2 as follows. That is, in step S3010, time information is further acquired in addition to the position information.

Then, in S3020, the intimacy degree identified in S2110 is registered in association with both the position information and the time information.

Furthermore, in S3030, the time information is transmitted to the server 1, in addition to the evaluation result obtained in S2210, the individual intimacy degree obtained at the time of the evaluation, and the position information associated with the intimacy degree.

According to such processing contents, the server 1 is capable of generating the safety map in accordance with the time of day. The processing contents (see FIG. 4) of the server 1 may be changed to generate or update the safety map, based on the intimacy degree corresponding to the time of day.

### Processing Contents of Mobile Terminal in The Present Service

FIG. 5 is a flowchart illustrating an example of processing contents of the mobile terminal 2. The present flowchart is started, for example, in response to the user U inputting a destination into the mobile terminal 2. Its outline is to notify a route through which the user U should pass, based on the safety map.

In S5010, the position information of the destination that has been input by the user U and the position information of the user U (the position information of the mobile terminal 2, that is, position information of the current location) at that time are registered on the map data.

In S5020, it is determined whether there are a plurality of candidates for the route from the current location of the user U to the destination on the map data. In a case where there are a plurality of candidate routes, the processing proceeds to S5030, and in the other case, the processing proceeds to S5110.

In S5030, the safety map is acquired from the server 1 through the network N.

In S5040, a recommended area for passing through is identified on the map data, as a recommended pass-through area, based on the safety map. The recommended pass-through area corresponds to an area where there are a large number of registration times of the intimacy degree (number of times of exchanging greetings or making conversation), that is, it can be said that such an area is high in safety.

In S5050, one route that passes through the recommended pass-through area is selected from the plurality of candidate routes. Note that in a case where there are two or more routes that pass through the recommended pass-through area, it is only necessary to select one, which has the shortest route length from the current location of the user U to the destination, of the two or more routes.

In S5110, a route through which the user U should pass from the current location of the user U to the destination is determined as a recommended route, and is notified to the user U. Here, in a case where there is one candidate route determined in S5020, such one route is determined as the recommended route, and in the other case (in a case where there are a plurality of candidate routes), such one route selected in S5050 is determined as the recommended route.

According to such processing contents, the user U is able to safely arrive at the destination, based on a notification on the mobile terminal 2 (while referring to the recommended route).

### Method for Determining Recommended Pass-Through Area

As described above, in the safety map, an area where a large number of third parties each having a high intimacy degree are present or frequently encountered is indicated as the first safe area. In addition, an area where a large number of third parties (for example, an elderly person who pays attention to the user U or a third party who is senior) each exchanging greetings with the individual user U are present even though the intimacy degrees are not high is indicated as the second safe area.

It can be said that the first and second safe areas are both relatively high in safety. However, with regard to the second safe area where a large number of third parties who exchange greetings are present even though the intimacy degrees are not high, it can be said that, in general, a regional watching system is organized with residents. Therefore, in S5050, out of the first and second safe areas, the recommended pass-through area may be desirably determined to pass through the second safe area on a priority basis.

As described above, the safety map is generated in a form corresponding to the time of day. On the other hand, in a case where the present service is mainly used when arriving at and leaving school (see the first embodiment), it can be said that the safety map can be used mainly on weekdays (Monday to Friday). For this reason, the safety maps for Saturday, Sunday, and a holiday may be desirably generated separately. In such a case, it is considered that a larger number of the users U who are grown-ups can contribute to generation of the safety map than the number of school students. Therefore, the users U who use the present service are not limited to school students.

Note that, here, the safety map that reflects the time of day and the day of the week has been given as examples, but a generalized safety map may be generated regardless of the time of day or the day of the week.

According to the present embodiment, it is advantageous for further improving the regional safety, which contributes to regional vitalization and development of the sustainable transportation system, accordingly.

### Application Example

In the present service, for example, by giving some reward to the user U who has contributed to the improvement of the regional safety, it becomes possible to enhance motivation of the individual user U in the region, and to further improve the regional safety. Giving the reward here refers to sending data indicating the reward to the mobile terminal 2 of the user U. Typical examples of the reward may include point(s) available at any store, but the reward may be any incentive. The presence or absence of a monetary value does not matter. The reward may be given at the time of evaluating the user U (at the timing of S2210), or may be given at the time of generating the safety map (at the timing of S4020).

### Others

In the above embodiments, the description has been given as an aspect with regard to the present service enabled by the processor mainly executing a program. However, without being limited to this, for example, a dedicated portable terminal may be used instead of the mobile terminal 2 in which the present program is installed. Such a dedicated portable terminal may be configured to include a processor capable of executing the present program, or may include an application specific integrated circuit (ASIC) that enables equivalent functions. That is, the processing contents that have been given as examples in the above embodiments are enabled by both hardware and software.

In addition, the contents that have been given as examples in the above embodiments can be changed without departing from the gist. For example, the order of steps illustrated in some flowcharts may be partially changed.

In the above description, in order to facilitate the understanding, each element is indicated with a name related to its functional aspect. However, each element is not limited to an element including the content described in the embodiments as a main function, but may be an element including the content as a supplementary function. Thus, each element may be replaced with a similar expression without being strictly limited by its expression.

Further, two or more elements selectively given as examples in the embodiments are not strictly limited to its examples, and may be optionally combined together. For example, each of two or more elements mentioned by “and/or” may be additionally or alternatively selected. As an example, for two elements of A and B, an expression “A and/or B” indicates any one of only A, only B, and both A and B, and may be rephrased as “at least one of A and B”.

### Summary of Embodiments

Some characteristics that have been given as examples in the above

embodiments are as follows.

### Item 1

An information management apparatus (1 and/or 2) that manages information about a user (U), the information management apparatus comprising:
an analysis unit (S2010-S2050) configured to analyze a conversation between the user and at least one third party different from the user;
an identification unit (S2110) configured to identify an intimacy degree (F) between the user and the at least one third party, based on an analysis result by the analysis unit; and
an evaluation unit (S2210) configured to evaluate the user, based on an identification result by the identification unit.

This makes it possible to promote improvement in sociability of the user, and achieve improvement in the regional safety, accordingly.

### Item 2

The information management apparatus according to claim 1, wherein
the analysis unit determines whether a predetermined phrase is included in the conversation (S2030), and
in a case where the predetermined phrase is included in the conversation, the identification unit identifies the intimacy degree.

This enables appropriate start of the analysis.

### Item 3

The information management apparatus according to claim 2, wherein
a plurality of types of phrases are each registered as the predetermined phrase, and
in a case where the predetermined phrase is included in the conversation, the identification unit identifies the intimacy degree, based on a type of the phrase.

This enables appropriate identification of the intimacy degree.

### Item 4

The information management apparatus according to claim 2, wherein
the predetermined phrase is a phrase indicating a greeting,
the analysis unit determines whether verbal communication has continued subsequent to the predetermined phrase in the conversation (S2050), and
the identification unit identifies the intimacy degree, further based on the verbal communication.

This further enables appropriate identification of the intimacy degree.

### Item 5

The information management apparatus according to claim 2, further comprising:
an acquisition unit configured to acquire position information of the user (S3010); and
a registration unit configured to register the position information of the user in a case where the predetermined phrase is included in the conversation (S3020).

This enables the information of the region to be managed in detail.

### Item 6

The information management apparatus according to claim 5, further comprising
a notification unit (S5110) configured to notify a route through which the user is to pass, based on the position information registered by the registration unit.

This makes it possible to present, to the user, for example, an appropriate route to the destination.

### Item 7

The information management apparatus according to claim 6, wherein
in a case where the predetermined phrase is included in the conversation, the registration unit further registers time information and
the notification unit notifies the route through which the user is to pass, based on the time information registered by the registration unit.

This makes it possible to present an appropriate route in accordance with the time.

### Item 8

The information management apparatus according to claim 1, wherein
the evaluation unit evaluates a lifestyle of the user.

This makes it possible to appropriately promote improvement in the user's lifestyle.

### Item 9

The information management apparatus according to claim 1, wherein
the information management apparatus is a mobile terminal (2).

That is, the above-described information management apparatus is applicable to a known mobile terminal such as a smartphone.

### Item 10

A System (SY) Comprising:
a server (1) serving as the information management apparatus according to claim 1; and
at least one mobile terminal (2) configured to be associated with at least one user, and configured to be able to communicate with the server.

That is, the above-described information management apparatus is applicable, as a server, to a system through a network.

### Item 11

A non-transitory computer-readable storage medium storing a program, the program configured to cause a computer to function as each unit of the information management apparatus according to claim 1.

That is, the functions of the above-described information management apparatus are enabled by a program.

The invention is not limited to the foregoing embodiments, and various variations/changes are possible within the spirit of the invention.

What is claimed is:

1. An information management apparatus that manages information about a user, the information management apparatus comprising:
an analysis unit configured to analyze a conversation between the user and at least one third party different from the user;
an identification unit configured to identify an intimacy degree between the user and the at least one third party, based on an analysis result by the analysis unit; and
an evaluation unit configured to evaluate the user, based on an identification result by the identification unit.

2. The information management apparatus according to claim 1, wherein
the analysis unit determines whether a predetermined phrase is included in the conversation, and
in a case where the predetermined phrase is included in the conversation, the identification unit identifies the intimacy degree.

3. The information management apparatus according to claim 2, wherein
a plurality of types of phrases are each registered as the predetermined phrase, and
in a case where the predetermined phrase is included in the conversation, the identification unit identifies the intimacy degree, based on a type of the phrase.

4. The information management apparatus according to claim 2, wherein
the predetermined phrase is a phrase indicating a greeting,
the analysis unit determines whether verbal communication has continued subsequent to the predetermined phrase in the conversation, and
the identification unit identifies the intimacy degree, further based on the verbal communication.

5. The information management apparatus according to claim 2, further comprising:
an acquisition unit configured to acquire position information of the user; and
a registration unit configured to register the position information of the user in a case where the predetermined phrase is included in the conversation.

6. The information management apparatus according to claim 5, further comprising
a notification unit configured to notify a route through which the user is to pass, based on the position information registered by the registration unit.

7. The information management apparatus according to claim 6, wherein
in a case where the predetermined phrase is included in the conversation, the registration unit further registers time information and
the notification unit notifies the route through which the user is to pass, based on the time information registered by the registration unit.

8. The information management apparatus according to claim 1, wherein
the evaluation unit evaluates a lifestyle of the user.

9. The information management apparatus according to claim 1, wherein
the information management apparatus is a mobile terminal.

10. A system comprising:
a server serving as the information management apparatus according to claim 1; and
at least one mobile terminal configured to be associated with at least one user, and configured to be able to communicate with the server.

11. A non-transitory computer-readable storage medium storing a program, the program configured to cause a computer to function as each unit of the information management apparatus according to claim 1.
